(19) United States
(12) Patent Application Publication
(10) Pub. No.: US 2008/0087686 A1
(43) Pub. Date: Apr. 17, 2008

(54) Apparatus and method for expelling a substance from a container

(76) Inventors: Omer Markovsky, Nez-Ziona (IL); Moshe Peles, Lapid (IL); Mark Robin Sheridan, Kfar Saba (IL); Vadim Genkin, Rehovot (IL); Lior Lewinz, Rehovot (IL)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/580,544

(22) Filed: Oct. 13, 2006

(51) Int. Cl. G01F 11/00

(52) U.S. Cl. 222/389

(57) ABSTRACT

An expulsion apparatus for the expulsion of a substance from a container includes a receptacle and a sealing unit. The receptacle serves to hold a container containing a substance. The sealing unit and the receptacle are connected in a way that causes pressurizing the sealing unit to substantially seal the receptacle, and that subsequent pressurization of the sealing unit pressurizes the sealed receptacle.

### FIELD AND BACKGROUND OF THE INVENTION

The present invention relates to expelling a substance from a container and, more particularly, but not exclusively to expelling a substance from a container by pressurizing the interior of the apparatus into which the container is inserted.

Offset printing is a widely used printing technique where the inked image is transferred (or offset) from a plate first to a rubber blanket, then to the printing surface. Offset printing is by far the most dominant form of commercial printing due to its quality in respect of volume and paper costs. As such, much effort is being directed to reducing the cost, time, and labor required for performing large-scale offset printing.

Currently, the process of replacing ink canisters in the printer is a time-consuming, labor-intensive process. The ink canister is housed in a receptacle, which must be manually opened and closed by an operator whenever the previous ink canister is empty. Since the expulsion of ink from the canister is often accomplished by regulating the pressure within the receptacle, the receptacle must be airtight to permit pressurization of the interior. Automating the task of opening and closing the receptacle would speed up the process of replacing ink cartridges, as all that would be required of the operator is to withdraw the old canister and replace it with the new canister. An additional reduction in operator time is possible, if the automated opening and closing permits the use of larger ink canisters, which must be changed less frequently.

FIG. 1 is an illustration of a typical ink canister. Canister body 4 is a rigid tube which holds the ink. Canister 4 is originally covered by plastic cover 1. The ink is contained in canister 4 between piston 2 and valve 3, through which the ink is expelled during printing. During printing, air pressure applied to piston 2 presses piston 2 down into the canister body 4, causing the ink to be expelled through valve 3. Note that for proper operation plastic cover 1 must first be removed or punctured, a task which is commonly performed manually during the replacement of ink canisters thus slowing the replacement process even further. Alternate ink canisters are available which are regulated by air pressure, including a bag which collapses when pressure is applied.

U.S. Pat. No. 6,474,233 by Kosciesza et al. describes an ink-supply device of a printing-machine inking unit, having a pressure discharge device, and a lid provided in the pressure discharge device for closing either a cartridge holder for accepting a cartridge, or a cartridge received directly in the pressure discharge device, respectively, an internal space being formed in one of the pressure discharge device and in a region located between the cartridge and the lid, respectively, the internal space being subjectable to an application of compressed air via a flow path provided with a valve. The lid is secured to the cartridge holder by means of a bayonet joint.

Furthermore, a device is described in the published German Patent Document DE 196 32 717 A1, wherein a cartridge can be inserted into a tubular housing. A fitted cap with a compressed-air connection can be set onto the tubular housing and locked on the housing by a bayonet lock-type mechanism. Both Kosciesza et al. and DE 196 32 717 A1 present ink canister receptacles in which a complex mechanical latching mechanism is required to secure the lid to the receptacle body.

There is currently no automatic, operator-friendly mechanism for securing ink canisters within their receptacles, that enables the regulation of ink expulsion during printing by pressurizing the interior of the receptacle.

There is thus a widely recognized need for, and it would be highly advantageous to have, an apparatus and method for expelling substances from a container, devoid of the above limitations.

### SUMMARY OF THE INVENTION

According to a first aspect of the present invention there is provided an expulsion apparatus for the expulsion of a substance from a container. The expulsion apparatus includes a receptacle and a sealing unit, where the receptacle serves to hold a container containing a substance. The sealing unit and the receptacle are connected in a way that causes pressurizing the sealing unit to substantially seal the receptacle, and that subsequent pressurization of the sealing unit pressurizes the sealed receptacle.

According to a second aspect of the present invention there is provided a printer which includes an expulsion apparatus for the expulsion of a substance from a container. The expulsion apparatus includes a receptacle and a sealing unit connected in a way that causes pressurizing the sealing unit to substantially seal the receptacle, and that subsequent pressurization of the sealing unit pressurizes the sealed receptacle. The printer further includes a pressurizer which increases and decreases pressurization of the sealing unit, and a controller which controls the pressurizer in accordance with printing requirements.

According to a third aspect of the present invention there is provided a method for expelling a substance from a container by: inserting a container containing the substance into a receptacle, and pressurizing a sealing unit to substantially seal the receptacle, and subsequently further pressurizing the sealing unit to pressurize the sealed receptacle.

According to a fourth aspect of the present invention there is provided a method for providing an expulsion apparatus. The expulsion apparatus includes a receptacle and a sealing unit connected in a way that causes pressurizing the sealing unit to substantially seal the receptacle, and that subsequent pressurization of the sealing unit pressurizes the sealed receptacle. The method includes the steps of: providing a receptacle configured for holding a container containing the substance, and connecting the receptacle to a sealing unit such that pressurizing the sealing unit substantially seals the receptacle, and subsequent pressurization of the sealing unit pressurizes the sealed receptacle.

The present invention successfully addresses the shortcomings of the presently known configurations by providing an apparatus, printer, and method for expelling a substance from a container utilizing air pressure. Pressurization of a portion of the expulsion apparatus automatically seals a receptacle holding a container, and may also automatically puncture a container lid and open a container valve to permit expulsion of the substance from the container.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is an illustration of a typical ink canister.

FIGS. 2a and 2b are simplified diagrams of an apparatus for the expulsion of a substance from a container, according to a first exemplary embodiment of the present invention.

FIGS. 2c and 2d are simplified diagrams of an apparatus for the expulsion of a substance from a container, according to a second exemplary embodiment of the present invention.

FIG. 3 is a simplified diagram of a sealing unit according to an exemplary embodiment of the present invention.

FIGS. 4a and 4b are simplified side views of a non-limiting exemplary embodiment of a canister valve, illustrating how applying pressure to the canister may control the opening and closing of the valve.

FIG. 5a is a simplified illustration of an expulsion apparatus, according to an exemplary embodiment of the present invention.

FIG. 5b is a simplified cross-sectional illustration of the expulsion apparatus of FIG. 5a.

FIG. 6 is a detailed cross-sectional illustration of the expulsion apparatus of FIG. 5a.

FIGS. 7a-7c illustrate an exemplary embodiment of the present invention in which the sealing unit is rotationally mounted on an axis.

FIG. 7d shows a further exemplary embodiment in which the expulsion apparatus includes a cam mechanism which allows the sealing unit and receptacle to rotate independently.

FIG. 8 is a simplified block diagram of a printer according to an exemplary embodiment of the present invention.

FIG. 9 is a simplified flowchart of a method for expelling a substance from a container, according to an exemplary embodiment of the present invention.

FIG. 10 is a simplified flowchart of a method for providing an expulsion apparatus for the expulsion of a substance from a container, according to an exemplary embodiment of the present invention.

### DESCRIPTION OF THE PREFERRED EMBODIMENTS

The present embodiments teach an expulsion apparatus which controls the sealing and unsealing of a receptacle holding a canister, and the expulsion of a substance from the canister by regulating the pressure within a portion of the expulsion apparatus. Specifically, the present embodiments teach an expulsion apparatus suitable for use in an offset printer, to easily insert and remove the ink can and to automatically control the expulsion of ink from the ink can by air pressure.

It is noted that the term “substance” (also denoted fluid herein) refers to any material which may be expelled through a canister valve or opening by applying pressure to the canister. Such substances may include liquids, gelatinous substances, solid particles, and so forth.

Furthermore, the scope of the term “container” (also denoted canister herein) is intended to encompass any container which may expel a fluid when placed under pressure.

The principles and operation of an expulsion apparatus according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

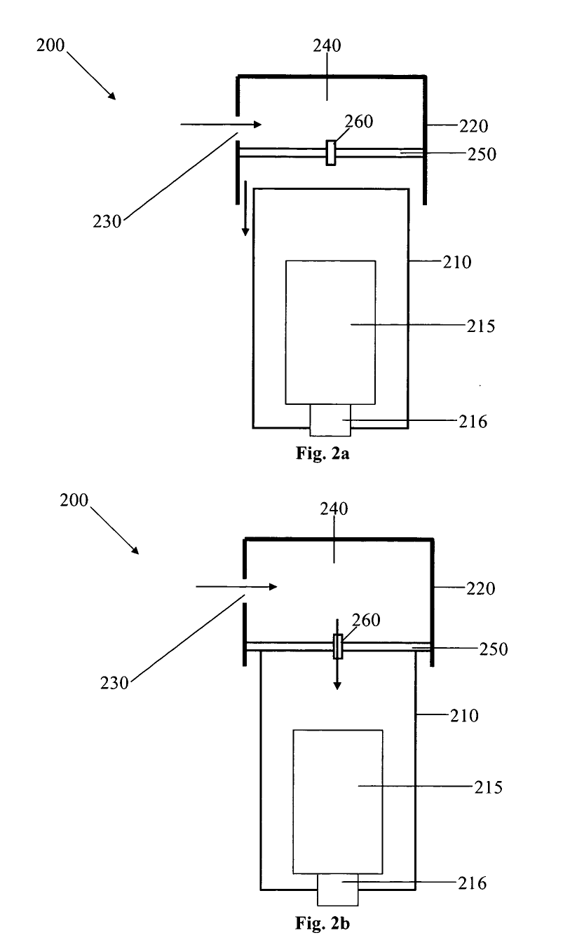

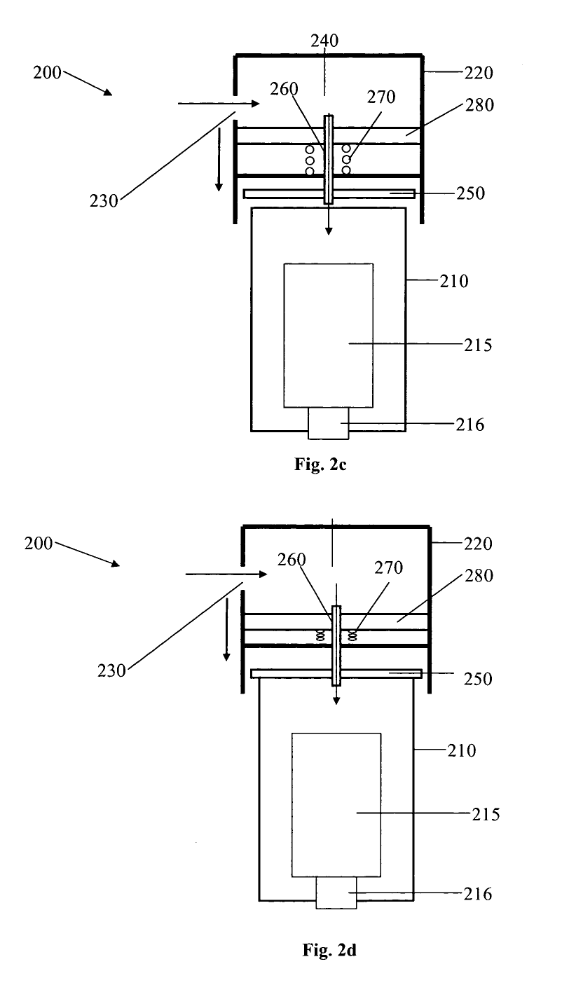

Reference is now made to FIGS. 2a and 2b, which are simplified diagrams of an apparatus for the expulsion of a fluid (i.e. substance) from a container, according to a first embodiment of the present invention. FIG. 2a shows expulsion apparatus in an unsealed state, whereas FIG. 2b shows expulsion apparatus 200 in a sealed state. Expulsion apparatus 200 includes receptacle 210, configured for holding container 215 containing the fluid, and sealing unit 220 which is connected to receptacle 210 in any way permitting sealing unit 220 to seal receptacle 210. For example, FIGS. 2a and 2b show a non-limiting embodiment in which sealing unit 220 is illustrated as a top fitting over receptacle 210. Other configurations are possible, such as a sealing unit into which the receptacle is inserted, as described below.

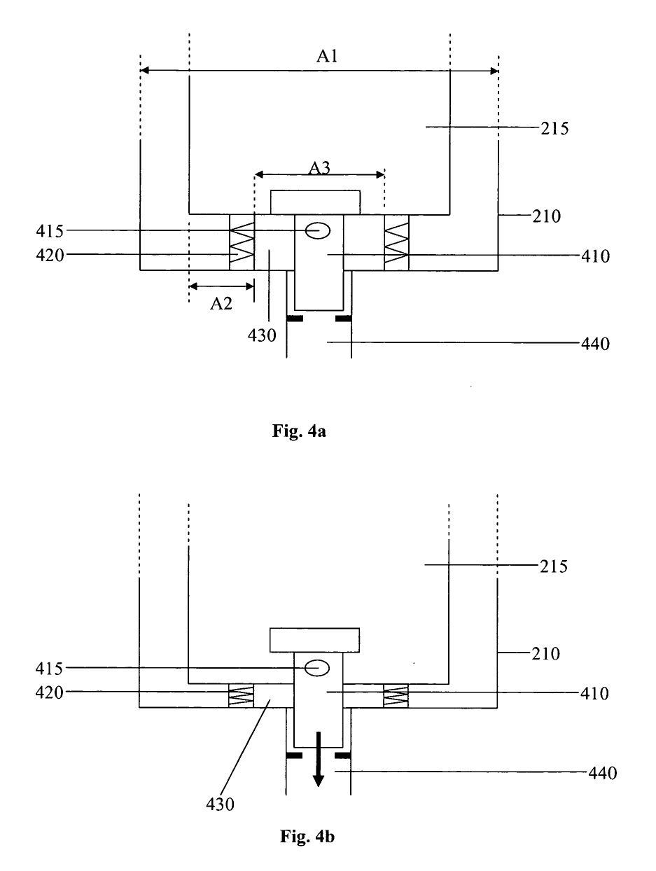

In a further embodiment container 215 includes valve 216, an exemplary embodiment of which is illustrated in FIGS. 4a and 4b.

In an exemplary embodiment, expulsion apparatus 200 is for use in a printer, specifically an offset printer, and container 215 is an ink can, typically containing ink in liquid or paste form.

As described in detail below, pressurizing sealing unit 220 substantially seals receptacle 210. Pressurization of sealing unit 220 may be accomplished by introducing pressurized gas into sealing unit 220 via inlet 230. The term “substantially seals” is to indicate that the receptacle is sealed to a degree permitting the pressurization of the interior of the receptacle.

FIGS. 2a and 2b illustrate an exemplary embodiment in which sealing unit 220 includes a pressurizable interior chamber 240, which houses a movable lid 250 capable of sealing receptacle 210. Pressurizing interior chamber 240 causes lid 250 to move within the interior chamber until lid 250 contacts the receptacle, thus sealing the receptacle.

In the present embodiment, lid 250 has an open passage 260. Before lid 250 contacts receptacle 210, any gas leaking out via passage 260 is released to the atmosphere. The diameter of passage 260 is designed to be smaller than inlet 230, so that there remains enough pressure to cause lid 250 to move down and seal receptacle 210.

Once receptacle 210 is sealed, additional pressurized gas introduced into the interior of sealing unit 220 passes through passage 260 and pressurizes the sealed receptacle 210. When pressure is released from sealing unit 220, the pressure within receptacle 210 is released via passage 260, until the point at which the receptacle unseals.

Reference is now made to FIGS. 2c and 2d, which are simplified diagrams of an apparatus for the expulsion of a fluid from a container, according to a further embodiment of the present invention. In the present embodiment, sealing unit 220 includes a more complex structure in which lid 250 is not pressed down directly by the pressurized gas. Rather, the pressure is applied to piston 280 which is connected to lid 250. Spring 270, which is located between piston 280 and the bottom of receptacle 220, causes piston 280 to move up when the pressurized air is released from sealing unit 220, thereby unsealing receptacle 210. Typically, the space surrounding spring 270 would be at atmospheric pressure so that a pressure differential will occur when sealing unit 220 is pressurized. Receptacle 210 may thus be sealed and unsealed automatically, by controlling the internal pressure within sealing unit 220.

Note that spring 270 may be any spring-like component, including a conventional spring, a gasket with spring-like properties, and so forth. Other automatic methods for unsealing receptacle 210 which do not require a spring may be used, for example by creating a positive pressure within the space between piston 280 and the bottom of receptacle 220, thus pushing piston 280 up.

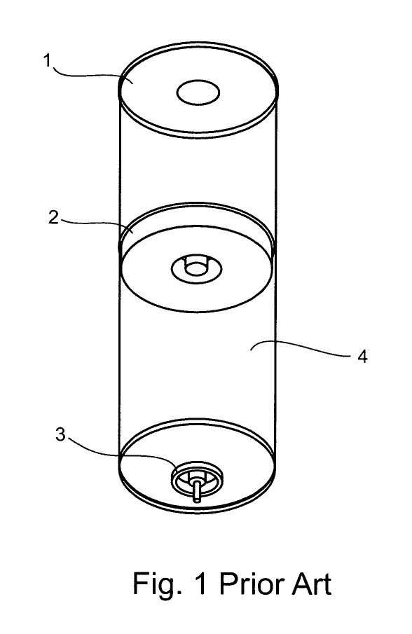

Container 215 may be held by receptacle 210 includes a collapsible portion, which contracts under pressure. Increasing the pressure within sealing unit 220 leads to an increase in pressure in receptacle 210, and causes the collapsible portion to contract thus expelling fluid from container 215. When pressure is released from sealing unit 220 the pressure within receptacle 210 drops, and the fluid is no longer expelled. For example, in FIG. 1, increasing the pressure on canister 4 causes piston 2 to move down and expel ink via valve 3.

The above discussion assumes that increasing the pressure within receptacle 210 applies a force onto the collapsible portion of container 215. However, as shown in FIG. 1 canister 4 may have a cover which must be opened before the canister can be used. A puncturer may be mounted on lid 250. The puncturer automatically penetrates an exterior of container 215 when lid 250 moves to seal receptacle 210. Once the container exterior is punctured, pressurizing the sealed receptacle leads to a corresponding increase in pressure in the interior of container 215.

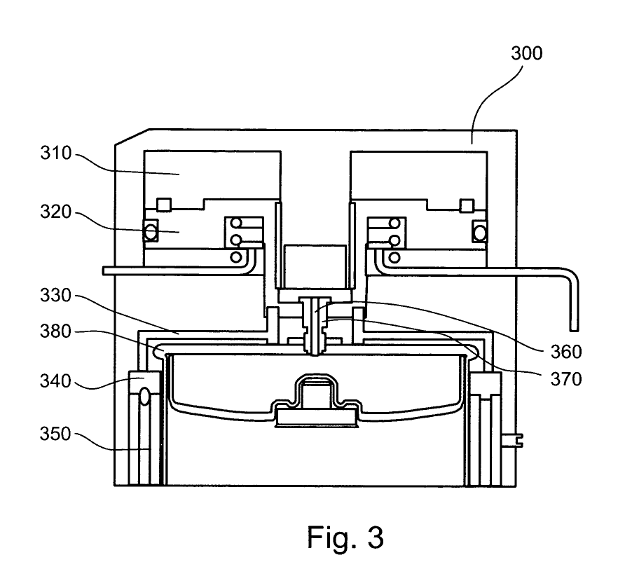

Reference is now made to FIG. 3, which is a simplified diagram of a sealing unit according to an exemplary embodiment of the present invention. Sealing unit 300 has an interior space serving as a piston housing 310, and a movable lid formed from a piston 320 connected to cover 330. Air is introduced into piston housing 310 via an inlet (not shown). The air pressure pushes piston 320 downward. The motion of piston 320 pushes cover 330 onto seal 340, and seals receptacle 350. Additionally, air flows through hole 360 from piston housing 310 into receptacle 350. The motion of cover 330 towards receptacle 350 also causes puncturer 370 to punch a hole in plastic cover 380, thereby admitting air into the canister. At the end of this procedure, receptacle 350 is sealed, and air pressurizes piston housing 310, receptacle 350 and the canister to the same pressure.

Canisters for dispensing fluids, such as ink cans, commonly have a valve which controls whether the fluid can or cannot be expelled from the canister at any given time. In order to expel the fluid the valve must first be opened. Only then will applying pressure to the canister force fluid out of the canister. In the present embodiment, the canister inserted into the receptacle includes such a valve, and pressurization of the interior of the receptacle controls the opening and closing of the valve, to permit the expulsion of the fluid from the canister. The expulsion apparatus may include an opposing surface against which the valve is pressed when the receptacle interior is pressurized, causing the valve to open.

Reference is now made to FIGS. 4a and 4b, which are simplified side views of a non-limiting exemplary embodiment of a canister valve, illustrating how applying pressure to the canister may control the opening and closing of the valve. In the present embodiment the canister is an ink can for use in an offset printer.

Can 215 includes a valve 410, and sits on a bottom seal 420 formed of a spring or material with elastic properties. When the interior of receptacle 210 is not pressurized the can remains relatively high in the receptacle. Valve opening 415 is not in contact with the fluid inside the can, and the valve is closed. When compressed (i.e. pressurized) air is supplied to receptacle 210, the pressurized air surrounds both sides of can 215, but does not reach sealed area 430 which is open to the atmosphere. A downward force is created on the can, pushing can 215 downward so that valve opening 415 is within the fluid. Valve 410 is open, and the fluid inside the can is expelled out of outlet 440. Note that protrusions within outlet 440 prevent valve 410 from moving down along with the can.

The force is generated on the can may be calculated according to the following relationship:

Fₜₒₜₐₗ≈P_{recept}*(A1−A2)=P_{recept}*(A3) (1)

where A₁ is the area of the upper projection of the can, A₂ is the area of the bottom projection of the can outside bottom seal 420, and P_{recept} is the pressure inside the receptacle.

In the present example, P_{recept} is a pressure of 4 bars, and the pressure within space 430 is 1 bar (i.e. atmospheric pressure). Since A1>A2, the force exerted on can 215 pushes can 215 down, and opens valve 410. Ink flows via opening 415 into the ink tank. When the pressure around can 215 is released, seal 420 pushes can 215 upwards and closes valve 410.

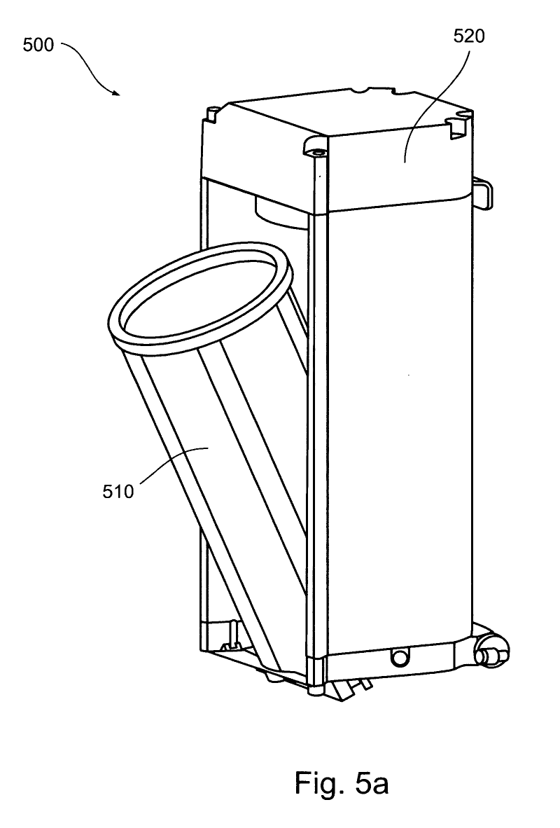

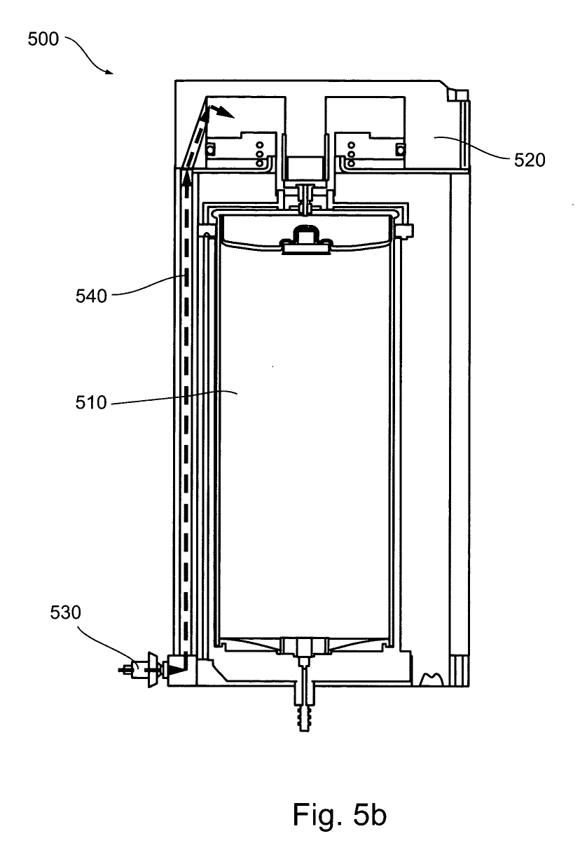

Reference is now made to FIG. 5a, which is a simplified illustration of an expulsion apparatus, according to an exemplary embodiment of the present invention. In expulsion apparatus 500, sealing unit 520 is a housing for receptacle 510, not a top fitting over receptacle 510. Receptacle 510 is mounted on an axis, and rotates into the interior of sealing unit 520.

Reference is now made to FIG. 5b, which is a simplified cross-sectional illustration of the expulsion apparatus of FIG. 5a. As shown in FIG. 5b, the top of sealing unit 520 incorporates a piston housing and a movable lid formed from a piston connected to a cover, substantially as shown in FIG. 3. Pressurized air is introduced into sealing unit 520 via air inlet 530 at the base of sealing unit 520, and is carried to piston housing 320 via air path 540.

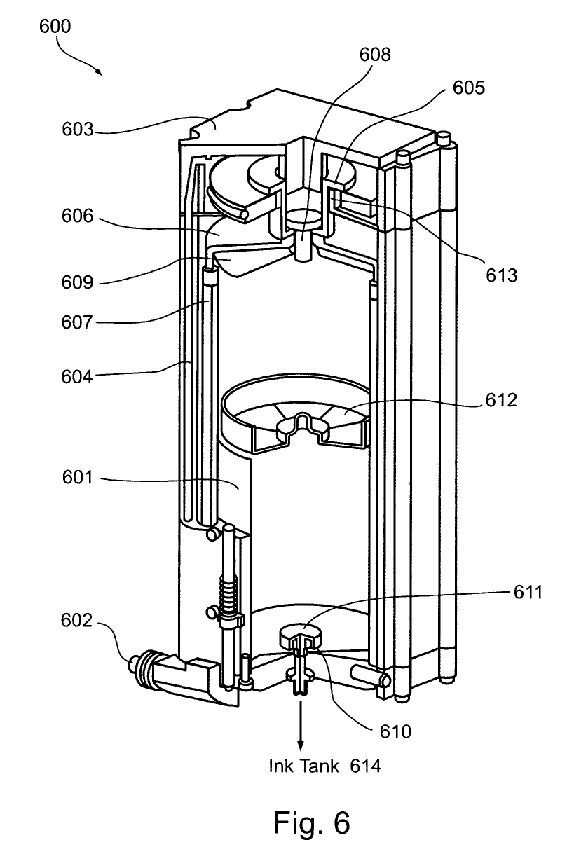

Reference is now made to FIG. 6, which is a detailed cross-sectional illustration of the expulsion apparatus of FIG. 5. The following description is directed at a non-limiting embodiment of an expulsion apparatus suitable for incorporation into an offset printer.

Expulsion apparatus 600 is configured to perform the functions of sealing the receptacle, puncturing the lid of ink can 601 placed within the receptacle, and controlling the opening of a fluid container valve. An external air supply tube is connected to the air inlet at the base of the sealing unit by fitting 602. The compressed air is channeled to piston housing 603 through air path 604. The compressed air pushes piston 605 down until cover 606 seals receptacle 607, and punch 608 penetrates ink can cover 609. Air pressure climbs inside receptacle 607 and presses ink can 601 against bottom seal 610 causing ink valve 611 to open. Plunger 612 then pushes the ink into ink tank 614. When air pressure is released from piston housing 603, piston spring 613 raises cover 306. The air pressure drops in receptacle 607 causing ink plunger 612 to stop moving, thus stopping the ink flow.

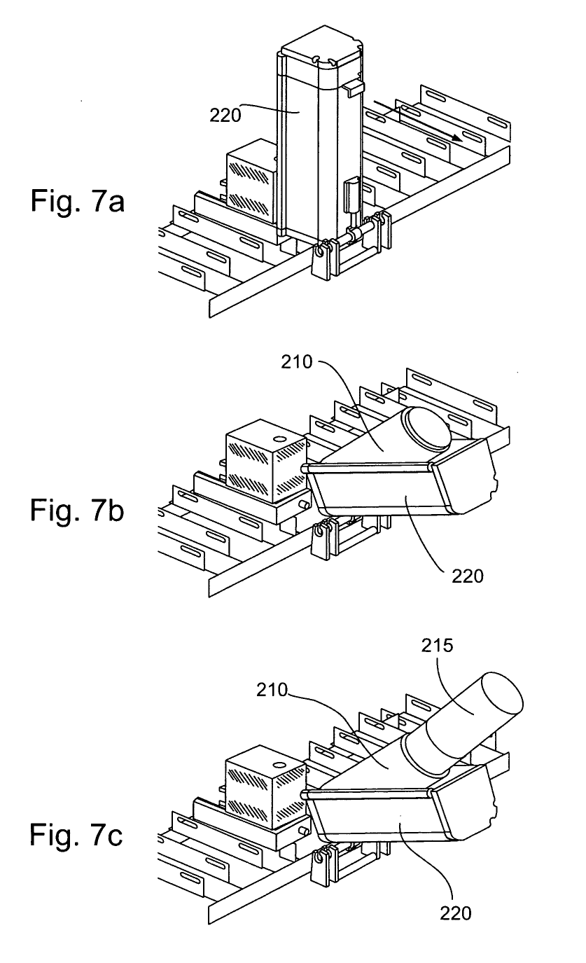

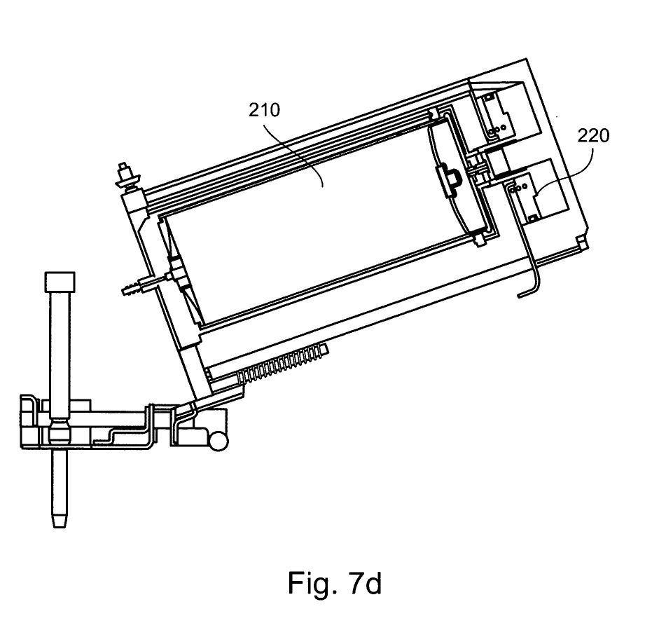

Reference is now made to FIGS. 7a-7c which illustrate a further embodiment of the present invention, in which the sealing unit 220 is rotationally mounted on an axis. The receptacle 210 is mounted on a second axis configured within the sealing apparatus in such a way that rotating the sealing unit 220 on its axis causes the receptacle 210 to rotate out of the sealing unit 220. FIG. 7a shows the expulsion apparatus in an upright, working position. When the handle on the sealing unit 220 is pulled in the direction of the arrow, the sealing unit 220 rotates and the receptacle 210 becomes accessible, as shown in FIG. 7b. FIG. 7c illustrates a container 215 being replaced in the receptacle 210. The sealing unit 220 may then be pushed upward. The receptacle 210 recedes into the sealing unit 220, and the expulsion apparatus is ready for operation. There is no need to manually seal or unseal the receptacle 210 in order to replace the container 215. All the operator need do is pull the handle of the sealing unit 220 and rotate the sealing unit 220 downwards.

FIG. 7d shows a further embodiment in which the expulsion apparatus includes a cam mechanism which allows the sealing unit 220 and receptacle 210 to rotate independently. With the cam mechanism removed, the receptacle 210 follows the sealing unit 220 axis as the sealing unit 220 is rotated, thus placing the expulsion apparatus in the calibration position shown in FIG. 7d.

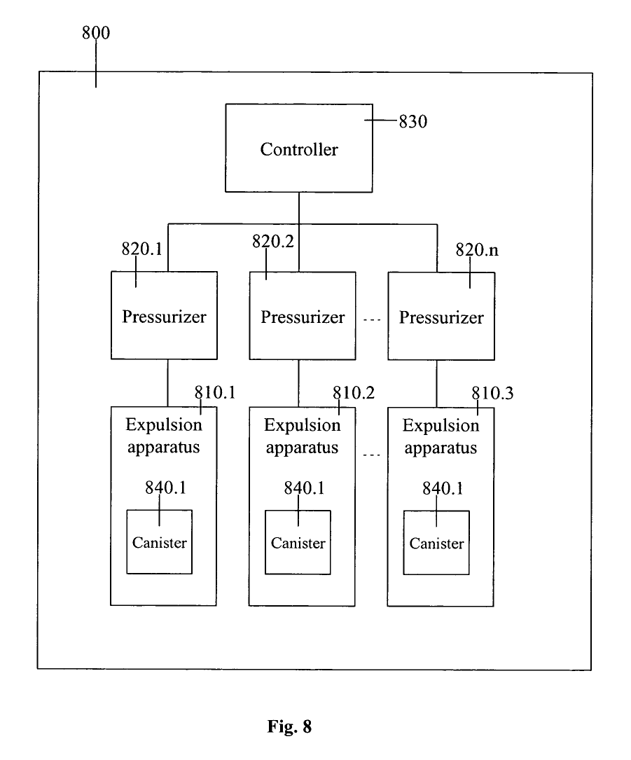

Reference is now made to FIG. 8, which is a simplified block diagram of a printer according to an exemplary embodiment of the present invention. Printer 800 includes at least one expulsion apparatus 810.l-810.n. The expulsion device includes a receptacle configured for holding a container containing the fluid and a sealing unit which is connected to the receptacle in any way permitting the sealing unit to seal the receptacle, substantially as described above. Each expulsion apparatus 810.x may be associated with a respective pressurizer 820.x, which serves to increase and decrease the pressure in the sealing unit. Printer 800 further includes controller 830 which controls the pressurizer(s) in accordance with printing requirements. Canisters 840.x are ink cans, each of which may contain a different color or type of ink. Note that FIG. 8 shows a non-limiting embodiment having more than one expulsion apparatus 810, however the present embodiment includes a printer 800 with a single expulsion apparatus 810.

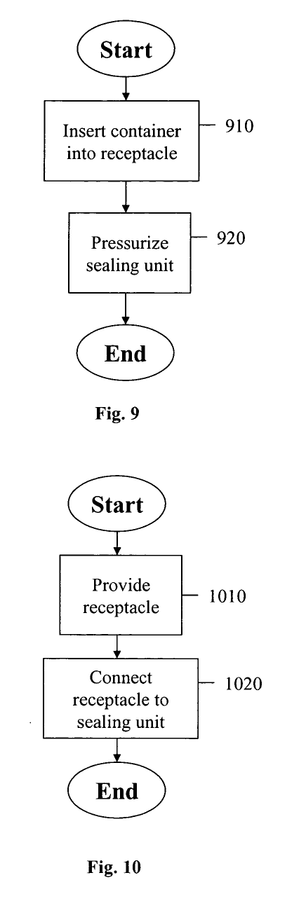

Reference is now made to FIG. 9, which is a simplified flowchart of a method for expelling a fluid from a container, according to an exemplary embodiment of the present invention. In step 910 a container containing the fluid is inserted into a receptacle. In step 920 a sealing unit is pressurized. As described above, pressurizing the sealing unit seals the receptacle. Further pressurization of the sealing unit then leads to an increase in pressure within the receptacle. The pressurization may further cause a puncturer on a movable lid forming the sealing unit to puncture the fluid canister within the receptacle and/or may open a valve on the fluid container to permit the expulsion of the fluid.

Reference is now made to FIG. 10, which is a simplified flowchart of a method for providing an expulsion apparatus for the expulsion of a fluid from a container, according to an exemplary embodiment of the present invention. In step 1010 a receptacle is provided. The receptacle is configured for holding a container containing the fluid, as described above. In step 1020, the receptacle is connected to a sealing unit to form an expulsion apparatus, in which pressurizing the sealing unit substantially seals the receptacle, and subsequent pressurization of the sealing unit pressurizes the sealed receptacle. In the present invention, the sealing unit includes a pressurizable interior chamber, a movable lid arranged within the interior chamber such that pressurizing the interior chamber moves the lid within the interior chamber, and a passage to the receptacle such that subsequent pressurization of the interior chamber opens the passage.

The expulsion apparatus described above provides a unified mechanism for performing the following functions:

1. Automatic sealing and unsealing of the receptacle holding the container

2. Automatic puncturing of the container lid

3. Automatic opening and closing of the container valve

All three functions are performed by controlling the pressure in the interior of the sealing unit. In a printing environment, the above-described embodiments enable easy insertion and removal of ink canisters from the printer, without the need to manually seal and unseal the receptacle into which the ink canister is inserted, or to open the ink canister prior to use. Controlling the opening and closing of the canister valve by the same pressurization mechanism allows the design of a simpler printer, since there is no need to incorporate an additional system for controlling the canister valve. Thus greater labor efficiency and a simpler printer design are obtained.

It is expected that during the life of this patent many relevant types of printers, canisters, ink cans, fluids, containers, and inks will be developed and the scope of the corresponding term printer, canister, ink can, fluid, container, and ink is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. An expulsion apparatus for the expulsion of a substance from a container, said expulsion apparatus comprising:
a receptacle, configured for holding a container containing said substance; and
a sealing unit operably associated with said receptacle, said association being such that initial pressurization of said sealing unit substantially seals said receptacle, and wherein subsequent pressurization of said sealing unit pressurizes said sealed receptacle.

2. An expulsion apparatus according to claim 1, wherein said substance comprises a fluid.

3. An expulsion apparatus according to claim 1, wherein said sealing unit comprises:
a pressurizable interior chamber; and
a movable lid arranged within said interior chamber, configured together such that said pressurizing moves said lid within said interior chamber to contact said receptacle, such that said receptacle is sealed.

4. An expulsion apparatus according to claim 3, wherein said movable lid comprises a puncturer operable to penetrate an exterior of said container such that an interior of said container is pressurized by said pressurization of said sealed receptacle.

5. An expulsion apparatus according to claim 1, wherein said receptacle is configured for holding a container comprising a collapsible portion operable to contract under pressure, such that said contraction expels said substance from said container.

6. An expulsion apparatus according to claim 1, wherein said receptacle is configured for holding a container comprising a valve for expelling said substance, such that said valve opens upon pressurization of said sealed receptacle, thereby to enable the expulsion of said substance from said container during pressurization.

7. An expulsion apparatus according to claim 1, wherein said sealing unit comprises an inlet configured to introduce and release pressurized gas from an interior of said sealing unit.

8. An expulsion apparatus according to claim 1, wherein said sealing unit comprises a spring-like portion configured to unseal said receptacle upon depressurization of said sealing unit.

9. An expulsion apparatus according to claim 1, said sealing unit being configured such that depressurization of said sealing unit substantially depressurizes the receptacle.

10. An expulsion apparatus according to claim 1, further comprising a pressurizer operable to increase and decrease pressurization of said sealing unit.

11. A printer comprising an expulsion apparatus according to claim 1, further comprising:
a pressurizer, operable to increase and decrease pressurization of said sealing unit; and
a controller associated with said pressurizer, operable to control said pressurizer in accordance with printing requirements.

12. A printer according to claim 11, wherein said printer comprises a plurality of expulsion apparatus, each of said expulsion apparatus being associated with a respective pressurizer.

13. A printer according to claim 11, wherein said substance comprises ink.

14. A method for expelling a substance from a container, comprising:
inserting a container containing said substance into a receptacle; and
pressurizing a sealing unit to substantially seal said receptacle, and subsequently further pressurizing said sealing unit to pressurize said sealed receptacle.

15. A method according to claim 14, wherein said pressurizing a sealing unit comprises:
introducing pressurized gas into an interior chamber of said sealing unit, such that a movable lid arranged within said interior chamber moves within said interior chamber to contact said receptacle.

16. A method according to claim 15, comprising utilizing a puncturer located on said movable lid to penetrate an exterior of said container such that an interior of said container is pressurized by said pressurization of said sealed receptacle.

17. A method according to claim 14, comprising opening a valve located on said container using a pressure of said sealed receptacle.

18. A method according to claim 14, pressing a valve located on said container against an opposing surface, thereby to open said valve.

19. A method for providing the expulsion apparatus of claim 1 comprising:
providing a receptacle configured for holding a container containing said substance; and
connecting said receptacle to a sealing unit such that pressurizing said sealing unit substantially seals said receptacle, and subsequent pressurization of said sealing unit pressurizes said sealed receptacle.

20. A method according to claim 19, further comprising providing a sealing unit comprising a pressurizable interior chamber and a movable lid arranged within said interior chamber, wherein said pressurizing moves said lid within said interior chamber to contact said receptacle, such that said receptacle is sealed.
